(19) United States
(12) Patent Application Publication
(10) Pub. No.: US 2025/0030333 A1
(43) Pub. Date: Jan. 23, 2025

(54) TRANSISTOR FAILURE DETECTION IN A POWER MODULE FROM THE PHASE VOLTAGE

(71) Applicant: VALEO SYSTEMES DE CONTROLE MOTEUR, Cergy Pontoise (FR)

(72) Inventors: Jean Raphael CAPOUNDA, Cergy Pontoise (FR); Cherif KERKAR, Cergy Pontoise (FR); Nicolas ALLALI, Cergy Pontoise (FR); Emmanuel TALON, Cergy Pontoise (FR)

(73) Assignee: VALEO SYSTEMES DE CONTROLE MOTEUR, Cergy Pontoise (FR)

(21) Appl. No.: 18/715,129

(22) PCT Filed: Dec. 2, 2022
(86) PCT No.: PCT/EP2022/084254

§ 371 Date: May 31, 2024

(30) Foreign Application Priority Data
Dec. 2, 2021 (FR) FR2112864

(51) Int. Cl. H02M 1/32; H02M 1/08; H02M 3/158

(52) U.S. Cl. CPC H02M 1/32; H02M 1/08; H02M 3/158

(57) ABSTRACT

Voltage conversion module including a high-voltage terminal, low-voltage terminal, ground terminal, an inductor, and a switching arm having a high-side switch and a low-side switch connected at a mid-point. The switching arm is connected between the high-voltage terminal and the ground terminal, the mid-point is electrically connected to the low voltage terminal via the inductor and a device for controlling the switches. The conversion module further includes a device for detecting failure of the high-side switch including a voltage generator having two input terminals and an output terminal and being configured to receive on one of its input terminals voltage of the mid-point, and on the other of its input terminals first reference voltage, and to generate on its output terminal an increasing voltage from a predetermined voltage lower than a threshold value provided that the voltage of the mid-point is higher than or equal to the first reference voltage.

The present invention relates to a voltage conversion module and to a DC/DC voltage converter comprising such a voltage conversion module.

In a known manner, many motor vehicles are equipped with a DC/DC (“Direct Current/Direct Current”) voltage converter configured to convert an input voltage, for example of 48 V, into a first output voltage, for example into 12 V. The DC/DC voltage converter is for example used to supply a battery, for example of 12 V, to be charged, or else to supply electrical equipment, such as a car radio.

These DC/DC voltage converters generally comprise one or more voltage conversion modules.

These voltage conversion modules comprise a high-voltage terminal intended to have a high voltage with respect to an electrical ground, a low-voltage terminal intended to have a low voltage with respect to the electrical ground, a ground terminal intended to be connected to the electrical ground, an inductor, a switching arm comprising a high-side switch and a low-side switch which are connected to each other at a mid-point, the switch arm being connected between the high-voltage terminal and the ground terminal, while the mid-point is electrically connected to the low-voltage terminal via said inductor in a first mode of operation of the voltage conversion module, and a device for controlling the switches which is designed to alternately place the switching arm in a high configuration and in a low configuration in the first mode of operation of the voltage conversion module, the high-side switch being closed and the low-side switch being open in the high configuration, the high-side switch being open and the low-side switch being closed in the low configuration.

Such a voltage conversion module implemented for example in the automotive field may, in the event that one of its switches fails, in particular the one on the high side, create short circuits which may irreversibly damage the voltage conversion module itself but also the equipment to which it is connected.

In order to solve this problem, according to a first aspect of the invention, it is proposed a voltage conversion module of the aforementioned type, characterized in that it further comprises a device for detecting a malfunction of short-circuit type of the high-side switch.

This device for detecting a malfunction of short-circuit type of the high-side switch comprises:
either a voltage generator comprising two input terminals and one output terminal, the voltage generator being configured to receive on one of its input terminals the voltage of the mid-point and on the other of its input terminals a first reference voltage, the voltage generator being further configured to generate on its output terminal a voltage increasing from a predetermined voltage less than a threshold value as long as the voltage of the mid-point is greater than or equal to the first reference voltage and to generate a voltage less than the threshold value in the opposite case, and a first voltage comparison module configured to compare the voltage at the output terminal of the voltage generator with the threshold value and to generate an error signal when the voltage at the output terminal is greater than the threshold value,
or a voltage generator comprising two input terminals and one output terminal, the voltage generator being configured to receive on one of its input terminals the voltage of the mid-point and on the other of its input terminals a first reference voltage, the voltage generator being further configured to generate on its output terminal a voltage decreasing from a predetermined voltage greater than a threshold value as long as the voltage of the mid-point is greater than or equal to the first reference voltage and to generate a voltage greater than the threshold value in the opposite case, and a first voltage comparison module configured to compare the voltage at the output terminal of the voltage generator with the threshold value and to generate an error signal when the voltage at the output terminal is less than the threshold value.

In the first alternative, when the high-side switch is closed, the voltage of the mid-point is greater than or equal to the first reference voltage and the voltage generator creates an increasing voltage on its output terminal. If this increasing voltage exceeds the threshold value, then the voltage of the mid-point has remained greater than or equal to the first reference voltage for an excessive period of time. In other words, the high-side switch has remained closed, i.e. on, for an excessive period of time, this being characteristic of a short circuit at this switch.

In the second alternative, when the high-side switch is closed, the voltage of the mid-point is greater than or equal to the first reference voltage and the voltage generator creates a decreasing voltage on its output terminal. If this decreasing voltage drops below the threshold value, then the voltage of the voltage of the mid-point has remained greater than or equal to the first reference voltage for an excessive period of time. In other words, the high-side switch has remained closed, i.e. on, for an excessive period of time, this being characteristic of a short circuit at this switch.

Thus, by monitoring the period of time for which the voltage of the mid-point is greater than or equal to the first reference voltage, it is possible, by virtue of the invention, to detect the short-circuiting of the high-side switch.

A voltage conversion module according to the invention may further comprise one or more of the following optional features, taken alone or else in any technically possible combination.

Optionally, the first reference voltage is less than or equal to the high voltage.

Optionally, the first reference voltage is equal to the voltage present at the low-voltage terminal or is equal to the voltage present at the low-voltage terminal added to a positive offset voltage.

Optionally, the positive offset voltage is constant.

Optionally, the first reference voltage is greater than or equal to the voltage present at the low-voltage terminal.

Optionally, the input terminal of the voltage generator receiving the first reference voltage is connected directly to the low-voltage terminal or to the output terminal of a voltage adder device having on its output terminal the voltage present at the low-voltage terminal added to a positive offset voltage.

Optionally, the predetermined voltage is equal to zero when the voltage generator is configured to generate an increasing voltage on its output terminal.

Optionally, the predetermined voltage is equal to the first reference voltage when the voltage generator is configured to generate a decreasing voltage on its output terminal.

Optionally, the high-side switch and/or the low-side switch are MOSFET (“Metal Oxide Semiconductor Field Effect Transistor”) transistors, for example made of silicon (Si-MOSFET) or of silicon carbide (SiC-MOSFET), or FET (“Field Effect Transistor”) transistors made of gallium nitride, or IGBT (“Insulated Gate Bipolar Transistor”) transistors.

Optionally, the voltage conversion module further comprises a safety device, this safety device connecting the inductor to the low-voltage terminal in the first mode of operation, the safety device disconnecting the inductor from the low-voltage terminal in a second mode of operation, the voltage conversion module operating in the second mode of operation when the error signal is generated.

Optionally, the device for controlling the switches is also designed to keep the low-side switch open in the second mode of operation.

Optionally, the voltage generator further comprises a ground terminal intended to be connected to the electrical ground, and a capacitor connected between the output terminal and the ground terminal of the voltage generator.

Optionally, the voltage generator configured to generate an increasing voltage on its output terminal further comprises:
a voltage supply terminal intended to receive a supply voltage;
a first resistor and a controllable switch, the first resistor and the controllable switch each being connected in parallel with the capacitor, the parallel connection of the first resistor, of the controllable switch and of the capacitor being intended to be connected between the voltage supply terminal and the ground terminal of the voltage generator, and
a second voltage comparison module configured to open the controllable switch when the voltage of the mid-point voltage is greater than the first reference voltage and to close it if not.

Optionally, the voltage conversion module further comprises a supply voltage source, the supply voltage source being connected to the supply terminal.

Optionally, the controllable switch is a transistor, for example a bipolar transistor, for example of NPN type.

Optionally, the voltage conversion module in which the voltage generator is configured to generate a decreasing voltage on its output terminal further comprises:
a first resistor and a controllable switch, the first resistor being connected in parallel with the capacitor, and the controllable switch being connected in series between the input terminal receiving the first reference voltage and the capacitor, and
a voltage divider configured to open the controllable switch when the voltage of the mid-point is greater than or equal to the first reference voltage and to close it if not.

Optionally, the voltage divider is connected between the input terminals of the voltage generator.

Optionally, the controllable switch is a transistor, for example a MOSFET transistor, for example of P type.

According to a second aspect of the invention, there is also proposed a voltage converter comprising at least one voltage conversion module according to the first aspect of the invention.

Optionally, this voltage converter comprises at least two voltage conversion modules according to the first aspect of the invention and the first voltage comparison module is common to said at least two voltage conversion modules.

Optionally, said at least two voltage conversion modules are connected in parallel between the high-voltage terminal and the low-voltage terminal.

Optionally, the first voltage comparison module comprises an input connected to the output terminal of the voltage generator via a diode.

Optionally, the diode is connected by its anode to the output terminal of the voltage generator.

According to a third aspect of the invention, there is also proposed an electrical system comprising an electrical ground, a high-voltage source with respect to the electrical ground and a voltage converter according to the second aspect of the invention and wherein the high-voltage terminal is connected to the high-voltage source and the ground terminal is connected to the electrical ground (M).

Optionally, the electrical system further comprises a load connected to the low-voltage terminal.

According to a fourth aspect of the invention, there is also proposed a mobility vehicle comprising a voltage conversion module according to the first aspect of the invention or a voltage converter according to the second aspect of the invention or else an electrical system according to the third aspect of the invention.

A mobility vehicle is for example a motor-driven land vehicle, an aircraft or a drone.

A motor-driven land vehicle is for example a motor vehicle, a motorbike, a motorized bicycle or a motorized wheelchair.

The invention will be better understood by means of the following description, which is given merely by way of an example and with reference to the appended drawings, in which:

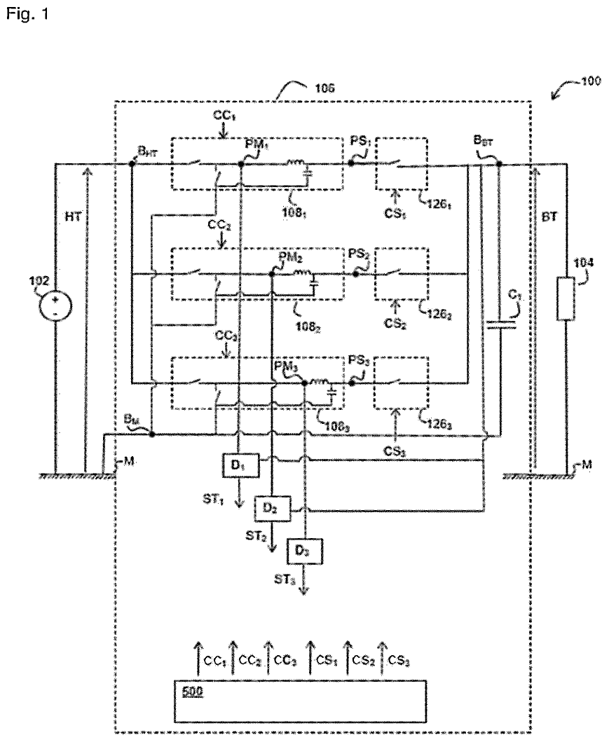

FIG. 1 is a block diagram of an example of an electrical system and DC/DC voltage converter in a first embodiment of the invention.

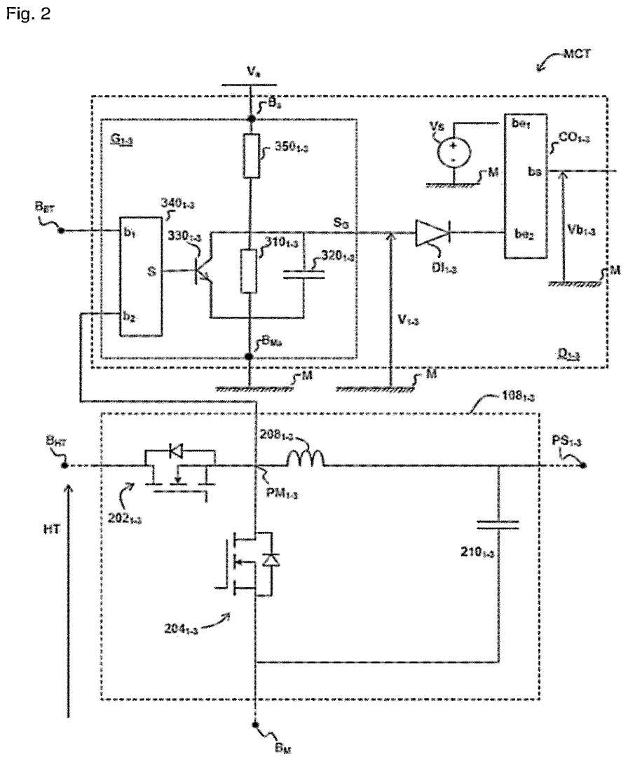

FIG. 2 is an electrical circuit illustrating the construction of a voltage conversion module of the DC/DC voltage converter of FIG. 1.

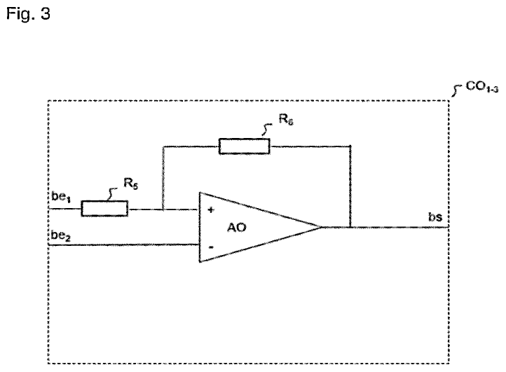

FIG. 3 is an electrical circuit illustrating a first voltage comparison module of the voltage conversion module of FIG. 2.

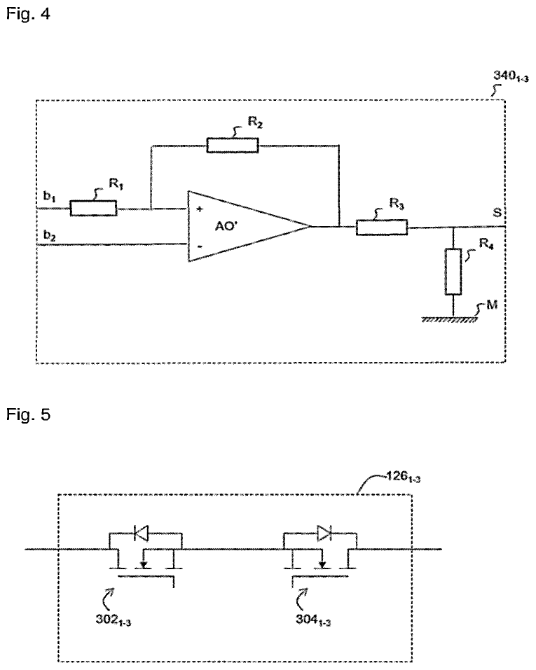

FIG. 4 is an electrical circuit illustrating a second comparison module of the voltage conversion module of FIG. 2.

FIG. 5 is an electrical circuit illustrating a safety device of a voltage conversion module of the DC/DC voltage converter of FIG. 1.

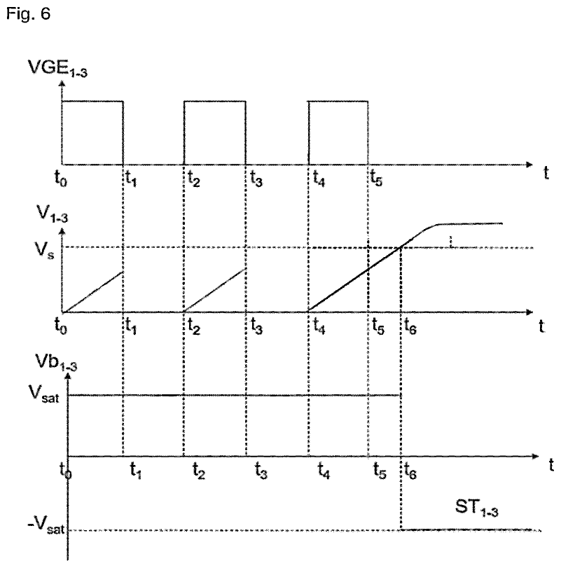

FIG. 6 shows, in the form of timing diagrams, the various electrical signals linking the evolution of the voltage of the mid-point of the switching arm and of the output of the first voltage comparison module of a voltage conversion module of FIG. 2.

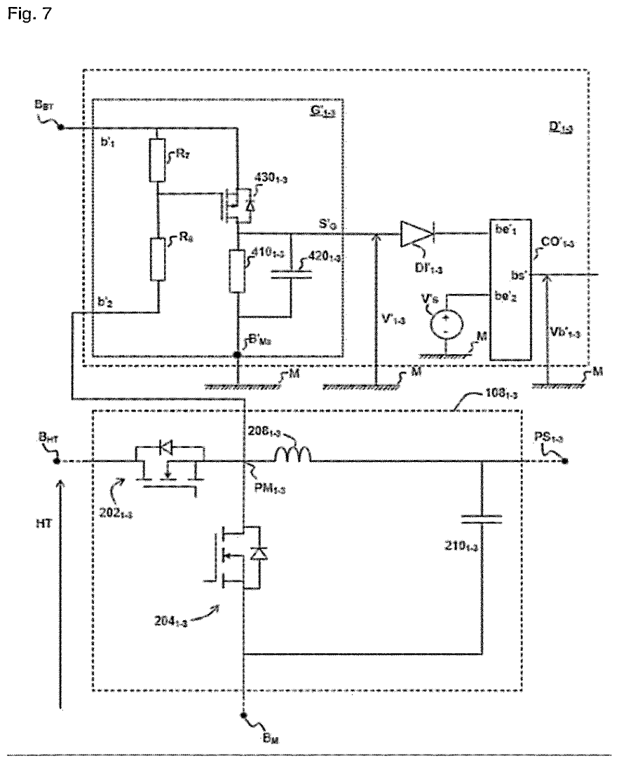

FIG. 7 is an electrical circuit illustrating a construction of a voltage conversion module in a second embodiment of the invention.

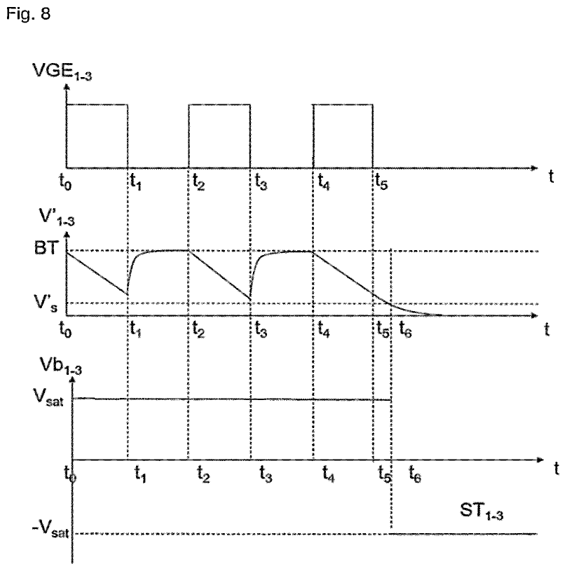

FIG. 8 shows, in the form of timing diagrams, the various electrical signals linking the evolution of the voltage of the mid-point of the switching arm and of the output of the first voltage comparison module of a voltage conversion module according to the second embodiment of the invention.

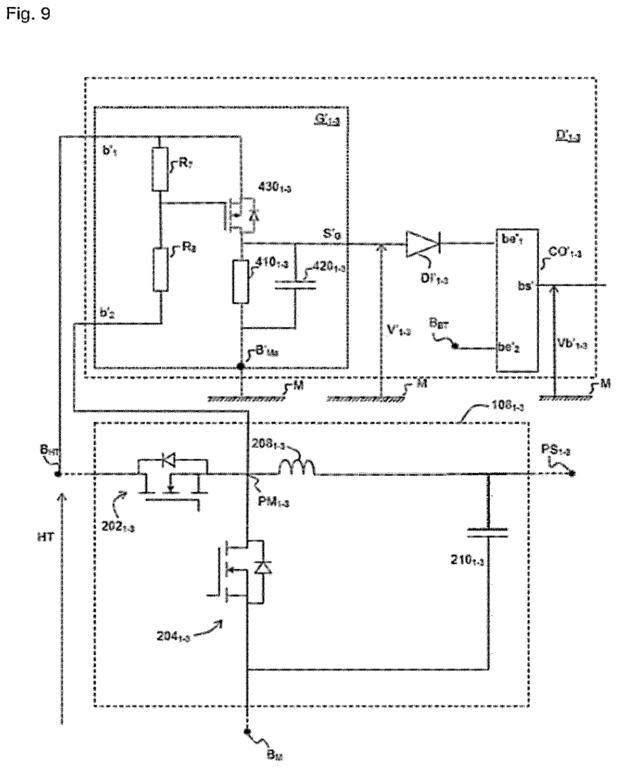

FIG. 9 is an electrical circuit illustrating a construction of a voltage conversion module in a third embodiment of the invention.

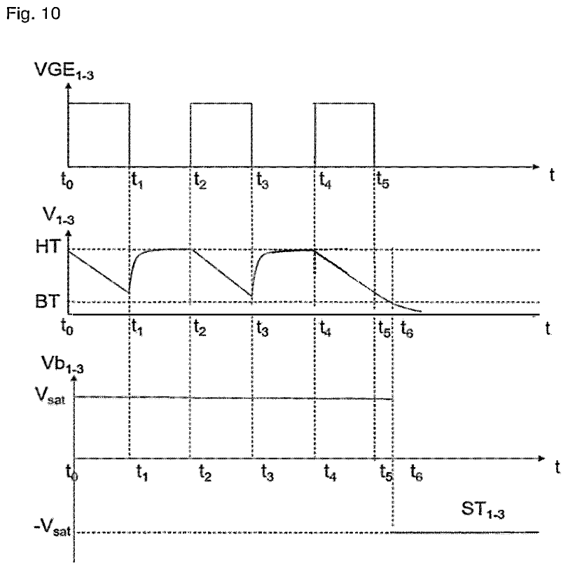

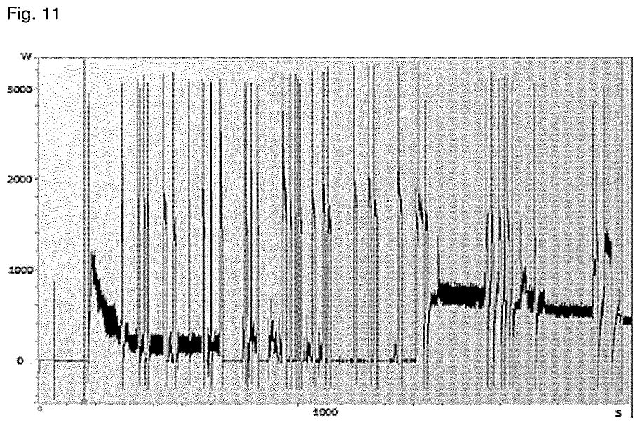

FIG. 10 shows, in the form of timing diagrams, the various electrical signals linking the evolution of the voltage of the mid-point of the switching arm and of the output of the first voltage comparison module of a voltage conversion module according to the third embodiment of the invention.

FIG. 11 describes a typical operating profile of the DC/DC voltage converter of FIG. 1 when it is integrated into a motor vehicle.

With reference to FIG. 1, an electrical system 100 intended to equip a mobility vehicle, for example a motor vehicle, will now be described in a first embodiment of the invention.

The system 100 firstly comprises an electrical ground M, a DC voltage source 102 (such as a battery) designed to supply a high voltage HT (for example 48 V) with respect to the electrical ground M, and a load 104 capable of being electrically supplied by a low voltage BT (for example 12 V) with respect to the electrical ground M.

In general, the high voltage HT is greater than the low voltage BT.

In order to obtain the low voltage BT from the high voltage HT, the system 100 further comprises a DC/DC voltage converter 106.

The DC/DC voltage converter 106 firstly comprises a ground terminal B_{M} connected to the electrical ground M, a high-voltage terminal B_{HT} connected to the DC voltage source 102 in order to have the high voltage HT with respect to the electrical ground M, a low-voltage terminal B_{BT} connected to the load 104 in order to have the low voltage BT with respect to the electrical ground M.

The DC/DC voltage converter further comprises a capacitor C, connected between the ground terminal B_{M} and the low-voltage terminal B_{BT}.

The DC/DC voltage converter 106 further comprises at least a number N greater than or equal to 1 of voltage conversion modules MCT connected in parallel between the high-voltage terminal B_{HT} and the low-voltage terminal B_{BT} to perform a conversion between the high voltage HT and the low voltage BT.

In the example described, the number N is equal to three, i.e. the DC/DC voltage converter 106 comprises three voltage conversion modules connected in parallel.

Each of these 3 voltage conversion modules MCT comprises a voltage conversion cell 108₁₋₃ which is electrically connected to the ground terminal B_{M}, to the high-voltage terminal B_{HT} and to an output point PS₁₋₃, a device D₁₋₃ for detecting a malfunction of this conversion cell 108₁₋₃, and a safety device 126₁₋₃ which is electrically connected to the output point PS₁₋₃ and to the low-voltage terminal B_{BT}.

In the example described, each cell 108₁₋₃ is a switching cell.

With reference to FIG. 2, the construction of these voltage conversion modules in the first embodiment of the invention will now be described.

Each cell 108₁₋₃ comprises a switching arm comprising a high-side switch 202₁₋₃ and a low-side switch 204₁₋₃ which are connected to each other at a mid-point PM₁₋₃. The switching arm is electrically connected between the high-voltage terminal B_{HT} and the ground terminal B_{M} to receive the high voltage HT.

The switches 202₁₋₃, 204₁₋₃ are for example transistor switches such as MOSFET transistors made of silicon (Si-MOSFETs) or of silicon carbide (SiC-MOSFETs).

In the example described here, the transistor 202₁₋₃ is of N type, its source is electrically connected to the mid-point PM₁₋₃ and its drain to the high-voltage terminal B_{HT}.

In the example described here, the transistor 204₁₋₃ is of N type, its source is electrically connected to the ground terminal B_{M} and its drain is electrically connected to the mid-point PM₁₋₃.

Each cell 108₁₋₃ further comprises an inductor 208₁₋₃ electrically connecting the mid-point PM₁₋₃ to the output point PS₁₋₃, and a capacitor 210₁₋₃ connecting the output point PS₁₋₃ to the electrical ground M, for example directly or else, as illustrated, by being connected to the ground terminal B_{M}. As a variant, the cells 108₁₋₃ do not comprise a capacitor 210₁₋₃.

Each cell 108₁₋₃ is coupled to a device D₁₋₃ for detecting a malfunction, said malfunction being linked to a short-circuiting of the high-side switch 202₁₋₃.

The device D₁₋₃ for detecting a malfunction comprises a voltage generator G₁₋₃ and a first voltage comparison module CO₁₋₃.

The voltage generator G₁₋₃ comprises two input terminals b₁, b₂ and one output terminal S_{G}.

This voltage generator G₁₋₃ is configured to receive on one of its input terminals the voltage of the mid-point PM₁₋₃ and on the other of its input terminals the voltage of the low-voltage terminal B_{BT}.

This voltage generator G₁₋₃ is further configured to generate on its output terminal S_{G} a voltage V₁₋₃ increasing from a predetermined voltage Vₘᵢₙ so long as the voltage of the mid-point PM₁₋₃ is greater than the voltage of the low-voltage terminal B_{BT} and to generate a voltage V₁₋₃ less than or equal to said predetermined voltage Vₘᵢₙ in the opposite case.

The first voltage comparison module CO₁₋₃ is configured to compare the voltage at the output terminal S_{G} of the voltage generator G₁₋₃ with a threshold value V_{S} and to generate an error signal ST₁₋₃ when the voltage at the output terminal of the voltage generator G₁₋₃ is greater than this threshold value V_{S}.

In the example described here, the first voltage comparison module CO₁₋₃ comprises two input terminals be₁, be₂ and one output terminal bₛ. One of the input terminals is connected to a voltage generator supplying the reference voltage Vₛ and the other input terminal is connected to the output terminal of the voltage generator G₁₋₃ preferably via a diode DI₁₋₃ the anode of which is connected to the output terminal of the voltage generator G₁₋₃.

The output terminal of the first voltage comparison module CO₁₋₃ has a first so-called “low” voltage level when the voltage at the output terminal of the voltage generator G₁₋₃ is greater than the threshold value V_{S}, and a second so-called “high” voltage level, which is greater than the first voltage level, in the opposite case. In other words, the error signal ST₁₋₃ corresponds to a “low” voltage level at the output terminal bₛ of the first voltage comparison module CO₁₋₃.

In one particular embodiment of the invention, the voltage generator G₁₋₃ comprises a voltage supply terminal Bₐ intended to receive a supply voltage Vₐ, a ground terminal B_{Ma} intended to be connected to the ground M, and a parallel connection of a resistor 310₁₋₃, of a capacitor 320₁₋₃ and of a controllable switch 330₁₋₃, this parallel connection being intended to be connected between the voltage supply terminal and the ground terminal of the voltage generator G₁₋₃.

In the exemplary embodiment described here, the controllable switch 330₁₋₃ is a bipolar transistor of npn type. In this example, the capacitor 320₁₋₃ and the resistor 310₁₋₃ are connected in parallel between the emitter and the collector of the bipolar transistor 330₁₋₃ while the emitter of the bipolar transistor 330₁₋₃ is connected to the ground terminal.

In this particular embodiment, the parallel connection described above is furthermore connected to the voltage supply terminal via a resistor 350₁₋₃. As a variant, the parallel connection described above is connected directly to the voltage supply terminal.

In this particular embodiment, the voltage generator G₁₋₃ further comprises a second voltage comparison module 340₁₋₃ configured to open the controllable switch 330₁₋₃ when the voltage of the mid-point PM₁₋₃ is greater than the voltage of the low-voltage terminal B_{BT} and to close it if not.

With reference to FIG. 3, the first voltage comparison module CO₁₋₃ will now be described.

The first voltage comparison module CO₁₋₃ comprises an operational amplifier AO and two resistors R₅ and R₆.

The output terminal of the operational operator AO is connected directly to the output terminal bₛ of the first voltage comparison module CO₁₋₃.

Resistor R₆ is connected by one of its terminals to the output terminal of the operational operator AO and by the other of its terminals to the + input of the operational amplifier AO.

The + input of the operational amplifier AO is furthermore connected via the resistor R₅ to the input terminal be₁ while the − input of the operational amplifier is connected directly to the input terminal be₂ of the first voltage comparison module CO₁₋₃.

Thus, if the hysteresis thresholds associated with this assembly are ignored, the output terminal of the operational amplifier AO has a negative saturation voltage when the input voltage on the terminal be₂ is greater than the input voltage on the terminal be₁ and a positive saturation voltage if not. In other words, the negative saturation voltage corresponds to the first so-called “low” voltage level and the positive saturation voltage corresponds to the second so-called “high” voltage level.

With reference to FIG. 4, the second voltage comparison module 340₁₋₃ will now be described.

The second voltage comparison module 340₁₋₃ comprises an operational amplifier AO′ and four resistors R₁, R₂, R₃ and R₄.

Resistor R₂ is connected by one of its terminals to the output terminal of the operational operator AO′ and by the other of its terminals to the + input of the operational amplifier AO′.

The + input of the operational amplifier AO′ is furthermore connected via the resistor R₁ to the input terminal b₁ while the − input of the operational amplifier is connected directly to the input terminal b₂ of the second voltage comparison module 340₁₋₃.

Thus, the output terminal of the operational operator AO′ has a negative saturation voltage when the input voltage on the terminal b₂ is greater than the input voltage on the terminal b₁ and a positive saturation voltage if not.

The output terminal of the operational operator AO′ is connected to the output terminal S of the second voltage comparison module 340₁₋₃ via a voltage divider bridge formed by the resistors R₃ and R₄. More specifically, the resistor R4 is connected by one of its terminals to the ground M and by the other of its terminals to the output S of the second voltage comparison module 340₁₋₃ while the resistor R3 is connected by one of its terminals to the output of the amplifier AO′ and by the other of its terminals to the output S of the second voltage comparison module 340₁₋₃.

With reference to FIG. 5, a safety device 126₁₋₃ will now be described.

Each safety device 126₁₋₃ comprises, for example, two transistor isolation switches 302₁₋₃, 304₁₋₃ connected in series and in opposition to each other. Thus, when they are both open, the safety device 126₁₋₃ is said to be open and the passage of current is prevented in both directions of flow. In particular, the passage of current through the reverse diode of one is then prevented by the other. Likewise, when the two isolation switches are both closed, the safety device is said to be closed and the low-voltage terminal B_{T} is connected to the output point PS₁₋₃.

In the example described in FIG. 3, the two transistor isolation switches 302₁₋₃, 304₁₋₃ are N-type MOSFET transistors connected by their source.

Returning to FIG. 1, it will now be explained how the DC/DC voltage converter 106 operates.

This DC/DC voltage converter 106 comprises a control device 500 designed to close the safety devices 126₁, 126₂, 126₃ by way of the control means CS₁, CS₂, CS₃ in a first mode of operation in order to perform a conversion between the high voltage HT and the low voltage BT.

In this first mode of operation, each cell 108₁₋₃ is designed to be controlled by controls CC₁₋₃ to alternately open and close the high-side 202₁₋₃ and low-side 204₁₋₃ switches in opposition to each other according to a duty cycle in order to convert the high voltage HT into the low voltage BT.

Moreover, the controls CC₁₋₃ are issued by the control device and they are phase-shifted by T/3 where T is the period of the operating cycle of the DC/DC voltage converter 106. In other words, the first duty cycle within each of the cells 108₁₋₃ is identical but the controls of the transistors are phase-shifted by T/3 from one cell to the other.

The control device is also designed to open the safety devices 126₁₋₃ and the low-side switches 204₁₋₃ in a second mode of operation so as to make the DC/DC voltage converter 106 safe.

Thus, when the safety devices 126₁, 126₂ and 126₃ are open, the first low-voltage terminal B_{BT} is electrically disconnected from the output points PS₁, PS₂ and PS₃.

In the first mode of operation of the DC/DC voltage converter 106, the voltage at the mid-point PM₁₋₃ is substantially equal to the high voltage HT when the high-side switch 202₁₋₃ is closed and is substantially equal to zero (ground potential M) when the high-side switch 202₁₋₃ is open.

Thus, when the high-side switch 202₁₋₃ is open, the second voltage comparison module 340₁₋₃ detects that the voltage of the mid-point PM₁₋₃ is less than the voltage of the low-voltage point and closes the controllable switch 330₁₋₃.

In the exemplary embodiment described here, the second voltage comparison module 340₁₋₃ emits, via its output terminal, a closing voltage on the gate of the bipolar switch 330₁₋₃. Since the bipolar transistor 330₁₋₃ is closed, the capacitor 320₁₋₃ is short-circuited and so the voltage at its terminals is zero.

The first voltage comparison module CO₁₋₃ compares the zero voltage across the terminals of the capacitor 320₁₋₃ with the reference value V_{S} and the first voltage comparison module CO₁₃ generates a “high” voltage level on its output terminal indicating that the voltage across the terminals of the capacitor 320₁₋₃ does not exceed the reference value V_{S}.

In contrast, when the high-side switch 202₁₋₃ is closed, the second voltage comparison module 340₁₋₃ detects that the voltage of the mid-point PM₁₋₃ is greater than the voltage of the low-voltage point and opens the controllable switch 330₁₋₃.

In the exemplary embodiment described here, the second voltage comparison module 340₁₋₃ emits, via its output terminal, an opening voltage on the gate of the bipolar switch 330₁₋₃. Since the bipolar transistor 330₁₋₃ is open, the capacitor 320₁₋₃ charges and so the voltage at its terminals increases from a predetermined voltage Vₘᵢₙ, in this case a predetermined zero voltage.

The first voltage comparison module CO₁₋₃ compares the voltage V₁₋₃ across the terminals of the capacitor 320₁₋₃ with the reference value V_{S} and the first voltage comparison module CO₁₋₃ generates a “low” voltage level when this voltage across the terminals of the capacitor 320₁₋₃ exceeds the reference value V_{S} and a “high” voltage level if not.

FIG. 6 shows, in the form of timing diagrams, the evolution of the control voltage VGE₁₋₃ of the high-side transistor 202₁₋₃, the evolution of the voltage V₁₋₃ across the terminals of the capacitor 320₁₋₃ and the evolution of the voltage Vb₁₋₃ at the output terminal of the first voltage comparison module CO₁₋₃.

Thus, in the first mode of operation of the DC/DC voltage converter 106, the high-side transistor 202₁₋₃ is successively closed during the time intervals [t₀, t₁], [t₂, t₃] and open during the time intervals [t₁, t₂], [t₃, t₄].

When the high-side transistor 202₁₋₃ is closed, the voltage of the mid-point PM₁₋₃ is substantially equal to the high voltage HT, the transistor 330₁₋₃ is open and the capacitor 320₁₋₃ charges. As can be seen in FIG. 6, the value of the capacitor 320₁₋₃, of the resistors 350₁₋₃ and 310₁₋₃ and the duty cycle of the cell 108₁₋₃ are chosen so that the voltage V₁₋₃ across the terminals of the capacitor 320₁₋₃ evolves almost linearly without, however, reaching the threshold voltage V_{S}.

When the high-side transistor 202₁₋₃ is open, the low-side switch 204₁₋₃ is closed, the voltage of the mid-point PM₁₋₃ is substantially equal to the voltage of the ground M, the transistor 330₁₋₃ is closed and the capacitor 320₁₋₃ is short-circuited. As shown in FIG. 6, the voltage V₁₋₃ across the terminals of the capacitor 320₁₋₃ is therefore zero.

In other words, the voltage V₁₋₃ across the terminals of the capacitor 320₁₋₃ evolves over time in the shape of saw teeth.

From time t₄, the high-side transistor 202₁₋₃ is closed, the voltage of the mid-point PM₁₋₃ is substantially equal to the high voltage HT, the transistor 330₁₋₃ is open and the capacitor 320₁₋₃ charges. At time t₅, the high-side transistor 202₁₋₃, although commanded to open, does not open and remains closed. Consequently, the voltage of the mid-point PM₁₋₃ remains substantially equal to the high voltage HT, the transistor 330₁₋₃ remains open and the capacitor 320₁₋₃ continues to charge until it exceeds the threshold value V_{S} at time t₆. Thus, at time t₆, the first voltage comparison module CO₁₋₃ detects this crossing of the threshold value V_{S} by the voltage across the terminals of the capacitor 320₁₋₃ and generates on its output terminal a “low” voltage level corresponding to the generation of an error signal ST₁₋₃.

Upon receiving this error signal, the control module of the DC/DC voltage converter 106 opens the safety devices 126₁, 126₂ and 126₃ and the low-side switches 204₁₋₃ so as to make the DC/DC voltage converter 106 safe by making it operate in its second mode of operation.

Thus, by monitoring the voltage level across the terminals of the capacitor 320₁₋₃, it is possible to detect that the high-side transistor 202₁₋₃ is in a closed state for an abnormally long period of time [t₄, t₆]. In other words, by monitoring the voltage level across the terminals of the capacitor 320₁₋₃, it is possible to detect that the high-side transistor 202₁₋₃ is short-circuited.

FIG. 11 describes a typical operating profile of the DC/DC voltage converter 106 integrated in a motor vehicle. More specifically, FIG. 11 shows the power delivered by the DC/DC voltage converter 106 over time during two different phases of use of the motor vehicle. During the first phase, corresponding to the left-hand part of the profile, the motor vehicle moves in a built-up area and each time the vehicle stops (for example at a stop or at a red light), the DC/DC voltage converter 106 is stopped (zero power delivered). During the second phase, corresponding to the right-hand part of the profile, the motor vehicle moves outside of a built-up area (for example on a national road) and the DC/DC converter 106 operates more smoothly.

When the DC/DC voltage converter 106 is not performing voltage conversion, the switches 202₁₋₃ and 202₁₋₄ are open and the voltage present at the mid-point PM₁₋₃ is slightly less (in particular due to the presence of the safety device 126₁₋₃ and the resistance of the inductor 208₁₋₃) than the voltage present at the low-voltage terminal B_{BT}. Due to this voltage difference, the second comparison module 340₁₋₃ closes the controllable switch 330₁₋₃ and no error signal ST₁₋₃ is generated by the first voltage comparison module CO₁₋₃. Thus, the second comparison module 340₁₋₃ makes it possible to avoid false detection of a short circuit of the high-side switch 202₁₋₃ by the device D₁₋₃ for detecting a malfunction when the DC/DC voltage converter 106 is not performing voltage conversion.

Moreover, the inventors have noticed that the voltage present at the low-voltage terminal B_{BT} can vary quite substantially over time, even if the DC/DC voltage converter 106 is not performing voltage conversion. Thus, the use of the voltage present at the low-voltage terminal B_{BT} as a voltage reference to trigger the closing of the controllable switch 330₁₋₃ by the second comparison module 340₁₋₃ instead of a fixed voltage reference also makes it possible to avoid false detections of a malfunction of the switch 202₁₋₃. As a result, the detection device D₁₋₃ is more robust.

In a variant embodiment of the electrical system 100, the second comparison module 340₁₋₃ compares the voltage of the mid-point PM₁₋₃ not with the voltage present at the low-voltage terminal but with the voltage present at the low-voltage terminal added to a positive offset voltage. In this way, the detection device D₁₋₃ is even more robust. To do this, the input terminal b₁ of the voltage generator G₁₋₃ is for example connected to the output terminal of a voltage adder device having on its output terminal the voltage present at the low-voltage terminal B_{BT} added to the positive offset voltage.

An electrical system 100′ intended to equip a mobility vehicle in a second embodiment of the invention will now be described.

The elements common and identical to the electrical system 100 described above will be designated by the same reference signs.

The electrical system 100′ differs from the electrical system by its DC/DC converter 106′. This DC/DC converter 106′ differs from the DC/DC converter 106′ by its three voltage conversion modules MCT′ which will now be described with reference to FIG. 7.

Each of these 3 voltage conversion modules comprises a voltage conversion cell 108₁₋₃, a device D′₁₋₃ for detecting a malfunction of this conversion cell 108₁₋₃, and a safety device 126₁₋₃ which is electrically connected to the output point PS₁₋₃ and to the low-voltage terminal B_{BT}.

The device D′₁₋₃ for detecting a malfunction comprises a voltage generator G′₁₋₃ and a first voltage comparison module CO′₁₋₃.

The voltage generator G′₁₋₃ comprises two input terminals b′₁, b′₂ and one output terminal S′_{G}.

This voltage generator G′₁₋₃ is configured to receive on one of its input terminals the voltage of the mid-point PM₁₋₃ and on the other of its input terminals a first reference voltage which, in the example described here, is equal to the voltage BT of the low-voltage terminal B_{BT}.

This voltage generator G′₁₋₃ is further configured to generate on its output terminal S′_{G} a voltage V′₁₋₃ decreasing from a predetermined voltage Vₘₐₓ greater than a threshold voltage V′ₛ as long as the voltage of the mid-point PM₁₋₃ is greater than the voltage of the low-voltage terminal B_{BT} and, if not, to generate a voltage V′₁₋₃ greater than the threshold voltage V′ₛ.

The first voltage comparison module CO′₁₋₃ is configured to compare the voltage at the output terminal S′_{G} of the voltage generator G′₁₋₃ with the threshold value V′ₛ and to generate an error signal ST′₁₋₃ when the voltage at the output terminal of the voltage generator G′₁₋₃ is less than this threshold value V′ₛ.

In the example described here, the first voltage comparison module CO′₁₋₃ comprises two input terminals be′₁, be′₂ and one output terminal b′ₛ. One of the input terminals is connected to the low-voltage terminal thus providing a reference voltage V′ₛ, and the other input terminal is connected to the output terminal of the voltage generator G′₁₋₃ preferably via a diode DI′₁₋₃ the anode of which is connected to the output terminal of the voltage generator G′₁₋₃.

The output terminal of the first voltage comparison module CO′₁₋₃ has a first so-called “low” voltage level when the voltage at the output terminal of the voltage generator G′₁₋₃ is less than the threshold value V′ₛ and a second so-called “high” voltage level, which is greater than the first voltage level, in the opposite case. In other words, the error signal ST′₁₋₃ corresponds to a “low” voltage level at the output terminal bs′ of the first voltage comparison module CO′₁₋₃.

In the exemplary embodiment described here, the first voltage comparator CO′₁₋₃ is structurally identical to the first voltage comparator CO₁₋₃ shown in FIG. 3.

Moreover, the voltage generator G′₁₋₃ comprises a ground terminal B′_{Ma} connected to the ground M, and a parallel connection of a resistor 410₁₋₃ and of a capacitor 420₁₋₃, this parallel connection being intended to be connected between the first input terminal b′₁ of the voltage generator G′₁₋₃ and the ground terminal of the voltage generator G′₁₋₃ via a controllable switch 430₁₋₃. The switch 430₁₋₃ is connected to the first input terminal b′₁ and to the parallel connection of the resistor 410₁₋₃ and of the capacitor 420₁₋₃.

In the exemplary embodiment described here, the controllable switch 430₁₋₃ is a P-type MOSFET the source of which is connected to the first terminal b′₁ and the drain of which is connected to the parallel connection of the resistor 410₁₋₃ and of the capacitor 420₁₋₃.

In addition, the voltage generation device G′₁₋₃ further comprises a voltage divider bridge connected between the first terminal b′₁ and the second input terminal b′₂ of the voltage generator G′₁₋₃.

This voltage divider bridge comprises a resistor R7 and a resistor R8 which are connected to each other at a connection point to which the gate of the MOSFET forming the controllable switch 430₁₋₃ is also connected.

FIG. 8 shows, in the form of timing diagrams, the evolution of the control voltage VGE₁₋₃ of the high-side transistor 202₁₋₃, the evolution of the voltage V′₁₋₃ across the terminals of the capacitor 420₁₋₃ and the evolution of the voltage Vb′₁₋₃ at the output terminal of the first voltage comparison module CO′₁₋₃.

Thus, in the first mode of operation of the DC/DC voltage converter 106′, the high-side transistor 202₁₋₃ is successively closed during the time intervals [t₀, t₁], [t₂, t₃] and open during the time intervals [t₁, t₂], [t₃, t₄].

When the high-side transistor 202₁₋₃ is closed, the voltage of the mid-point PM₁₋₃ is substantially equal to the high voltage HT, the transistor 430₁₋₃ is open and the capacitor 420₁₋₃ discharges through the resistor 410₁₋₃. As can be seen in FIG. 8, for a given positive threshold value V′_{S}, the value of the capacitor 420₁₋₃ and the duty cycle of the cell 108₁₋₃ are chosen so that the voltage V′₁₋₃ across the terminals of the capacitor 420₁₋₃ decreases almost linearly from a value Vₘₐₓ equal to the low voltage BT without, however, reaching the threshold voltage V′ₛ.

When the high-side transistor 202₁₋₃ is open, the low-side switch 204₁₋₃ is closed, the voltage of the mid-point PM₁₋₃ is substantially equal to the voltage of the ground M, the transistor 430₁₋₃ is closed and the capacitor 420₁₋₃ charges. As shown in FIG. 6, the capacitor 420₁₋₃ charges almost instantaneously and the voltage V′₁₋₃ across the terminals of the capacitor 420₁₋₃ returns to the voltage BT.

In other words, the voltage V′₁₋₃ across the terminals of the capacitor 320₁₋₃ evolves over time in the shape of saw teeth.

From time t₄, the high-side transistor 202₁₋₃ is closed, the voltage of the mid-point PM₁₋₃ is substantially equal to the high voltage HT, the transistor 430₁₋₃ is open and the capacitor 420₁₋₃ discharges. At time t₅, the high-side transistor 202₁₋₃, although commanded to open, does not open and remains closed. Consequently, the voltage of the mid-point PM₁₋₃ remains substantially equal to the high voltage HT, the transistor 430₁₋₃ remains open and the capacitor 320₁₋₃ continues to discharge until it passes below the threshold value V′ₛ at time t₆. Thus, at time t₆, the first voltage comparison module CO′₁₋₃ detects this crossing of the threshold value V′ₛ by the voltage across the terminals of the capacitor 420₁₋₃ and generates on its output terminal a “low” voltage level corresponding to the generation of an error signal ST′₁₋₃.

Upon receiving this error signal, the control module of the DC/DC voltage converter 106′ opens the safety devices 126₁, 126₂ and 126₃ and the low-side switches 204₁₋₃ so as to make the DC/DC voltage converter 106′ safe by making it operate in its second mode of operation.

Thus, by monitoring the voltage level across the terminals of the capacitor 420₁₋₃, it is possible to detect that the high-side transistor 202₁₋₃ is in a closed state for an abnormally long period of time [t₄, t₆]. In other words, by monitoring the voltage level across the terminals of the capacitor 420₁₋₃, it is possible to detect that the high-side transistor 202₁₋₃ is short-circuited.

In this second embodiment of the invention, the voltage generator G′₁₋₃ is configured to compare the voltage of the mid-point PM₁₋₃ with the voltage of the low-voltage terminal B_{BT} in order to avoid false detections of a malfunction of the switch 202₁₋₃ in cases where, for example, the DC/DC voltage converter 106′ does not perform voltage conversion.

An electrical system 100″ intended to equip a mobility vehicle in a third embodiment of the invention will now be described.

The elements common and identical to the electrical system 100′ described above will be designated by the same reference signs.

The electrical system 100″ differs from the electrical system by its DC/DC converter 106″. This DC/DC converter 106″ differs from the DC/DC converter 106′ on the three following points:
The terminal b′₁ of the voltage generator G′₁₋₃ is connected to the high-voltage terminal and not to the low-voltage terminal,
The terminal be′₂ of the first voltage comparator CO′₁₋₃ is connected to the low-voltage terminal BT and not to a voltage generator supplying the reference voltage V′ₛ, i.e. the value of the reference voltage V′ₛ is chosen to be equal to the low voltage BT, and
The numerical values of the components of the device D′₁₋₃ for detecting a malfunction are adapted to the modifications described in the two preceding points.

FIG. 9 shows, in the form of timing diagrams, the evolution of the control voltage VGE₁₋₃ of the high-side transistor 202₁₋₃, the evolution of the voltage V′₁₋₃ across the terminals of the capacitor 420₁₋₃ and the evolution of the voltage Vb′₁₋₃ at the output terminal of the first voltage comparison module CO′₁₋₃ in this third embodiment of the invention.

It will moreover be noted that the invention is not limited to the embodiments described above. Specifically, it will be obvious to those skilled in the art that various modifications may be made to the embodiments described above, in light of the teaching that has just been disclosed to them.

For example, pull-down resistors may optionally be placed on the input terminals of the comparators described above.

Moreover, in a variant embodiment, the first voltage comparison module is common to all of the voltage conversion modules. In other words, each of the voltage conversion modules comprises a voltage generator G₁₋₃ or G′₁₋₃ the output terminal of which is connected directly or via a diode DI₁₋₃ or DI′₁₋₃ to the terminal of one single first voltage comparison module.

Likewise, instead of being MOSFET transistors, the high-side 202₁₋₃ and low-side 204₁₋₃ switches may be FET transistors made of gallium nitride, or IGBT transistors.

Likewise, instead of being implemented by means of a bipolar transistor, the controllable switch 330₁₋₃ may be an FET transistor, for example a MOSFET or an IGBT transistor.

In addition, instead of having a negative saturation voltage and a positive saturation voltage, the operational amplifiers AO and AO′ may have a zero saturation voltage and a positive saturation voltage.

In the detailed presentation of the invention that was given above, the terms that were used must not be interpreted as limiting the invention to the embodiments disclosed in the present description, but must be interpreted as including all equivalents conceivable by a person skilled in the art applying her or his general knowledge to the implementation of the teaching that has just been disclosed.

1. A voltage conversion module comprising:
a high-voltage terminal intended to have a high voltage with respect to an electrical ground;
a low-voltage terminal intended to have a low voltage with respect to the electrical ground;
a ground terminal intended to be connected to the electrical ground;
an inductor;
a switching arm comprising a high-side switch and a low-side switch which are connected to each other at a mid-point, the switching arm being connected between the high-voltage terminal and the ground terminal, while the mid-point is electrically connected to the low-voltage terminal via said inductor in a first mode of operation of the voltage conversion module; and
a device for controlling the switches which is designed to alternately place the switching arm in a high configuration and in a low configuration in the first mode of operation of the voltage conversion module the high-side switch being closed and the low-side switch being open in the high configuration, the high-side switch being open and the low-side switch being closed in the low configuration;
said voltage conversion module being wherein it further comprises:
a device for detecting a malfunction of short-circuit type of the high-side switch, comprising:
either a voltage generator comprising two input terminals and one output terminal, said voltage generator being configured to receive on one of its input terminals the voltage of the mid-point and on the other of its input terminals a first reference voltage, said first reference voltage being less than or equal to said high voltage, said voltage generator being further configured to generate on its output terminal a voltage increasing from a predetermined voltage less than a threshold value as long as the voltage of the mid-point is greater than or equal to the first reference voltage and to generate a voltage less than the threshold value in the opposite case, and a first voltage comparison module configured to compare the voltage at said output terminal of the voltage generator with said threshold value and to generate an error signal when said voltage at the output terminal is greater than said threshold value,
or a voltage generator comprising two input terminals and one output terminal, said voltage generator being configured to receive on one of its input terminals the voltage of the mid-point and on the other of its input terminals a first reference voltage, said first reference voltage being less than or equal to said high voltage, said voltage generator being further configured to generate on its output terminal a voltage decreasing from a predetermined voltage greater than a threshold value as long as the voltage of the mid-point is greater than or equal to the first reference voltage and to generate a voltage greater than the threshold value in the opposite case, and a first voltage comparison module configured to compare the voltage at said output terminal of the voltage generator with said threshold value and to generate an error signal when said voltage at the output terminal is less than said threshold value.

2. The voltage conversion module as claimed in claim 1, further comprising a safety device, said safety device connecting said inductor to said low-voltage terminal in the first mode of operation, said safety device disconnecting said inductor from said low-voltage terminal in a second mode of operation, said voltage conversion module operating in the second mode of operation when said error signal is generated.

3. The voltage conversion module as claimed in claim 2, wherein the device for controlling the switches is also designed to keep the low-side switch open in the second mode of operation.

4. The voltage conversion module as claimed in claim 1, wherein the voltage generator further comprises a ground terminal intended to be connected to said electrical ground, and a capacitor connected between said output terminal and said ground terminal of the voltage generator.

5. The voltage conversion module as claimed in claim 4, wherein said voltage generator configured to generate an increasing voltage on its output terminal further comprises:
a voltage supply terminal intended to receive a supply voltage;
a first resistor and a controllable switch, said first resistor and said controllable switch each being connected in parallel with said capacitor, said parallel connection of said first resistor, of said controllable switch and of said capacitor being intended to be connected between said voltage supply terminal and said ground terminal of the voltage generator, and
a second voltage comparison module configured to open the controllable switch when the voltage of the mid-point is greater than the first reference voltage and to close it if not.

6. The voltage conversion module as claimed in claim 5, further comprising a supply voltage source, said supply voltage source being connected to said supply terminal.

7. The voltage conversion module as claimed in claim 5, wherein said controllable switch is a transistor, for example a bipolar transistor, for example of NPN type.

8. The voltage conversion module as claimed in claim 4, wherein said voltage generator configured to generate a decreasing voltage on its output terminal further comprises:
a first resistor and a controllable switch, said first resistor being connected in parallel with said capacitor, and said controllable switch being connected in series between the input terminal receiving the first reference voltage and said capacitor, and
a voltage divider configured to open the controllable switch when the voltage of the mid-point is greater than or equal to the first reference voltage and to close it if not.

9. The voltage conversion module as claimed in claim 8, wherein said controllable switch is a transistor, for example a MOSFET transistor, for example of P type.

10. A voltage converter comprising at least one voltage conversion module as claimed in claim 1.

11. A voltage converter comprising at least two voltage conversion modules as claimed in claim 1 and wherein the first voltage comparison module is common to said at least two voltage conversion modules.

12. An electrical system comprising an electrical ground, a high-voltage source with respect to the electrical ground, and a voltage converter as claimed in claim 10 and wherein the high-voltage terminal is connected to the high-voltage source and the ground terminal is connected to the electrical ground.

13. The electrical system as claimed in claim 12, further comprising a load, said load being connected to the low-voltage terminal.

14. A mobility vehicle comprising a voltage conversion module as claimed in claim 1.

15. The voltage conversion module as claimed in claim 2, wherein the voltage generator further comprises a ground terminal intended to be connected to said electrical ground, and a capacitor connected between said output terminal and said ground terminal of the voltage generator.

16. The voltage conversion module as claimed in claim 6, wherein said controllable switch is a transistor, for example a bipolar transistor, for example of NPN type.

17. A voltage converter comprising at least one voltage conversion module as claimed in claim 2.

18. A voltage converter comprising at least two voltage conversion modules as claimed in claim 2 and wherein the first voltage comparison module is common to said at least two voltage conversion modules.

19. An electrical system comprising an electrical ground, a high-voltage source with respect to the electrical ground, and a voltage converter as claimed in claim 11 and wherein the high-voltage terminal is connected to the high-voltage source and the ground terminal is connected to the electrical ground.

20. A DC/DC voltage converter as claimed in claim 10.
